(19) United States
(12) Patent Application Publication
(10) Pub. No.: US 2023/0334064 A1
(43) Pub. Date: Oct. 19, 2023

(54) SYSTEM INCLUDING PEER-TO-PEER NETWORK INVOLVED IN BLOCKCHAIN, METHOD FOR SUPPORTING CONSTRUCTION OF THE SAME PEER-TO-PEER NETWORK, AND SMART CONTRACT EXECUTED ON PEER

(71) Applicant: HITACHI, LTD., Tokyo (JP)

(72) Inventor: Hiroyuki NARUMI, Tokyo (JP)

(21) Appl. No.: 18/028,792

(22) PCT Filed: Oct. 13, 2020
(86) PCT No.: PCT/JP2020/038660

§ 371 Date: Mar. 28, 2023

(51) Int. Cl. G06F 16/27

(52) U.S. Cl. CPC G06F 16/27

(57) ABSTRACT

A peer-to-peer network includes multiple peers each of which is provided with a general-purpose smart contract in which general-purpose processing independent of an entity is defined, and each of which stores schema definition information including an entity definition of each of one or more entities associated with the general-purpose smart contract. The general-purpose smart contract is configured to: receive designation of an entity name; specify an entity having the designated entity name from the schema definition information; and perform processing on the specified entity.

### TECHNICAL FIELD

The present invention relates generally to a blockchain.

### BACKGROUND ART

A technique called a “blockchain” is known. At the time of filing of the present application, definitions below are provided by the Japan Blockchain Association as definitions of blockchains. The definition of the blockchain related to the present invention may be a definition (1) below or a broad definition (2) below. The blockchain may be interpreted as an example of a distributed ledger technology, or an example of the distributed ledger technology may be interpreted as the blockchain.
(1) A blockchain is defined as a protocol, or implementation of a protocol, used by an unspecified number of nodes containing Byzantine faults, and converges the probability of consensus reversion with the passage of time to zero.
(2) In a broader sense, a blockchain is a technology with a data structure which can easily detect manipulation using digital signatures and hash pointers, and where the data has high availability and integrity due to distribution across multiple nodes on a network.

Known examples of an open-source blockchain include the Hyperledger Fabric (trademark). Known examples of a standard software development kit (SDK) for system development using the Hyperledger Fabric include Hyperledger Fabric SDK for node.js (referred to below as “Fabric Node SDK”).

### CITATION LIST

### Non Patent Literature

NPL 1: Hyperledger Fabric SDK for node.jshttps://hyperledger.github.io/fabric-sdk-node/release-1.4/module-fabric-network.html

### SUMMARY OF INVENTION

### Technical Problem

The Hyperledger Fabric (Apache License 2.0) is used to develop a service (e.g., an application) based on a blockchain network serving as a peer-to-peer network using an application programming interface (API) provided by the Fabric Node SDK. When the service is executed, a special program called a chain code is required to register and refer to data in the blockchain network. Thus, the chain code needs to be developed and deployed in the development of the service.

The chain code is developed for each entity. Specifically, when the chain code is coded, a definition of an entity corresponding to the chain code and a definition of processing for operating the entity are described, and a value of an entity operated by the chain code is input as an argument in instantiation of the chain code.

To develop the chain code, knowledge about a blockchain and knowledge about an API for chain code development are required as a premise, and coding of the chain code is required for each entity. These requirements cause a relatively high development difficulty level, and low development productivity of the service.

Additionally, the chain code exists for each entity, so that a large burden is imposed on maintenance of service.

The above problem is one of hurdles for practical use of a service based on a blockchain network. Although the chain code is an example of a smart contract, a smart contract in a blockchain other than the Hyperledger Fabric may have a problem as described above.

### Solution to Problem

A peer-to-peer network includes multiple peers each of which is provided with a general-purpose smart contract in which general-purpose processing independent of an entity is defined, and each of which stores schema definition information including an entity definition of each of one or more entities associated with the general-purpose smart contract. The general-purpose smart contract is configured to: receive designation of an entity name; specify an entity having the designated entity name from the schema definition information; and perform processing on the specified entity.

### Advantageous Effects of Invention

Development productivity of services based on a blockchain network is improved, and a maintenance burden is reduced.

### BRIEF DESCRIPTION OF DRAWINGS

FIG. 1 illustrates a configuration of an entire system according to an embodiment of the present invention.

FIG. 2 illustrates a peer according to a comparative example.

FIG. 3 illustrates a peer according to an embodiment of the present invention.

FIG. 4 illustrates an example of schema definition information.

FIG. 5 illustrates an example of a schema definition UI.

FIG. 6 illustrates an example of schema definition information input to a general-purpose chain code, and storage and control according to the schema definition information.

FIG. 7 illustrates another example of schema definition information input to a general-purpose chain code and storage according to the schema definition information.

FIG. 8 illustrates an example of a flow of instantiation processing.

FIG. 9 illustrates an example of a flow of registration processing.

FIG. 10 illustrates an example of a flow of transaction processing other than registration processing.

FIG. 11 illustrates a trigger for upgrade of a general-purpose chain code.

FIG. 12 illustrates an outline of a configuration and storage of an entity.

### DESCRIPTION OF EMBODIMENTS

In the following description, an “interface device” may be one or more interface devices. The one or more interface devices may be at least one of the following.
One or more input/output (I/O) interface devices. An input/output (I/O) interface device is an interface device for at least one of an I/O device and a remote display computer. The I/O interface device for the display computer may be a communication interface device. The at least one I/O device is a user interface device that may be any one of an input device such as a keyboard or a pointing device, and an output device such as a display device.
One or more communication interface devices. The one or more communication interface devices may be one or more communication interface devices of the same type (e.g., one or more network interface cards (NIC)) or two or more communication interface devices of different types (e.g., an NIC and a host bus adapter (HBA)).

In the following description, a “memory” is one or more memory devices that are each an example of one or more storage devices, and may typically be a main storage device. The at least one memory device in the memory may be a volatile memory device or a nonvolatile memory device.

In the following description, a “permanent storage device” may be one or more permanent storage devices that are each an example of one or more storage devices. The permanent storage device may typically be a nonvolatile storage device (e.g., an auxiliary storage device), and specifically may be a hard disk drive (HDD), a solid state drive (SSD), a non-volatile memory express (NVNE) drive, or a storage class memory (SCM), for example.

In the following description, a “storage device” may be at least a memory of the memory and a permanent storage device.

In the following description, a “processor” may be one or more processor devices. Although the at least one processor device may typically be a microprocessor device such as a central processing unit (CPU), it may be another type of processor device such as a graphics processing unit (GPU). The at least one processor device may be a single core or a multi-core. The at least one processor device may be a processor core. The at least one processor device may be a processor device in a broad sense such as a circuit (e.g., a field-programmable gate array (FPGA), a complex programmable logic device (CPLD), or an application specific integrated circuit (ASIC)) that is an aggregate of gate arrays in a hardware description language, the circuit performing a part or all of processing.

Although processing may be described with a “chain code” as a subject in the following description, the chain code is executed by a processor to perform determined processing appropriately using a storage device and/or an interface device, and thus the subject of the processing may be the processor (or a device or a system including the processor).

In the following description, when elements identical in kind are described without being distinguished, common reference numerals among reference numerals may be used, and when elements identical in kind are described while being distinguished, reference numerals may be used.

Embodiments below take the Hyperledger Fabric as an example, and thus a chain code is taken as an example as a smart contract.

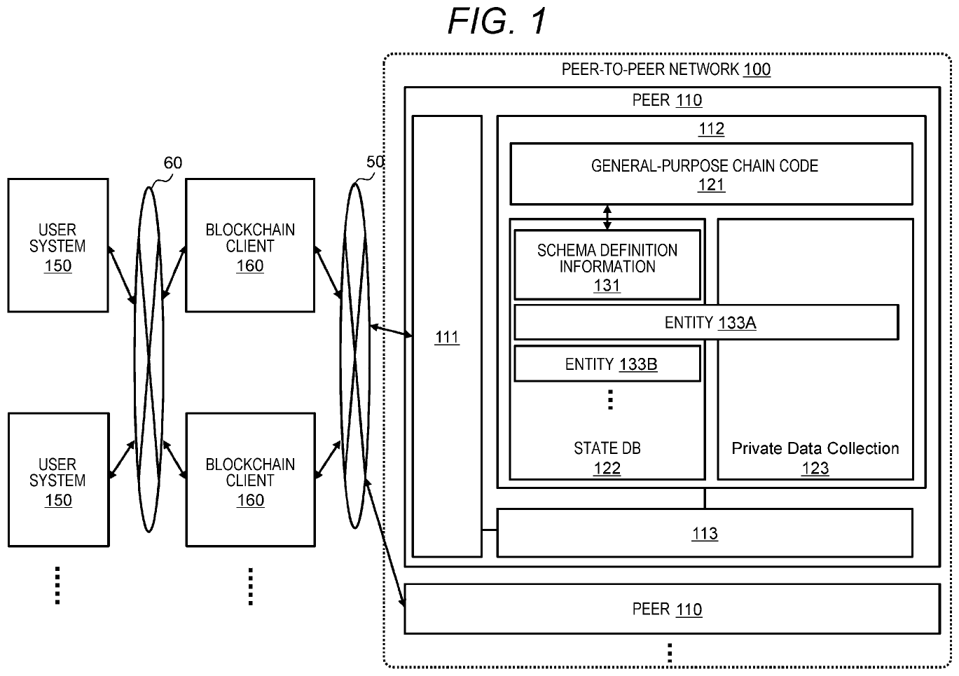

FIG. 1 illustrates a configuration of an entire system according to an embodiment of the present invention.

There is a blockchain services infrastructure as a system involved in the Hyperledger Fabric and including a peer-to-peer network 100 composed of multiple authorized peers 110. There is a blockchain client 160 that communicates with a blockchain service infrastructure via a network 50. The blockchain client 160 may be a physical computer or a logical computer (e.g., a virtual computer) implemented by a physical computer. The blockchain client 160 communicates with a user system 150 that is a computer system of a user (e.g., a company using a blockchain service infrastructure) via a network 60. The networks 50 and 60 may be the same network. Communication between the peers 110 may be performed via the network 50 or may be performed via a dedicated network (not illustrated). Capabilities of the blockchain client 160 may be included in the peer 110.

The peer-to-peer network 100 may be an example of a distributed system, and the peer 110 may be an example of a node in the distributed system. The peer 110 includes an interface device 111, a storage device 112, and a processor 113 connected thereto. The interface device 111 is connected to the network 50. The storage device 112 stores a general-purpose chain code 121, and schema definition information 131. As an example of data store based on the storage device 112, a state database (DB) 122 and a private data collection 123 are provided. The state DB 122 and the private data collection 123 store one or more entities 133 (133A, 133B, . . . ). The entity 133 is data (e.g., a table). Depending on the schema definition information 131, the entity 133 is determined to be stored only in the state DB 122 or stored across the state DB 122 and the private data collection 123. The “state DB” may be referred to as a “world state” or a “public state”. The “private data collection” may be referred to as a “private state”.

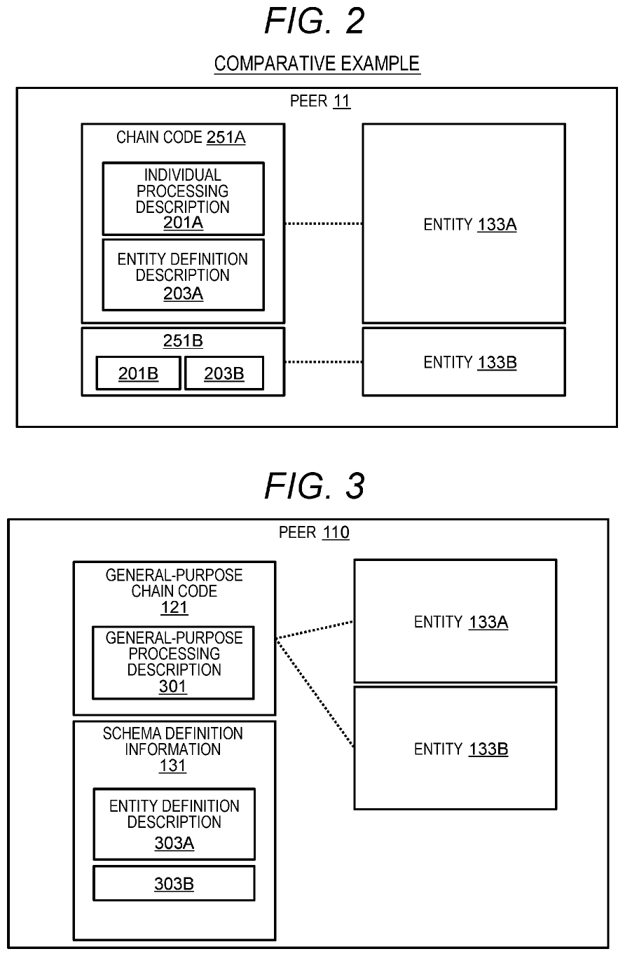

FIG. 2 illustrates a peer according to a comparative example.

When multiple entities 133 are stored in the peer 11 in the comparative example, the chain code 251 needs to be coded for each entity 133. For example, a developer needs to code a chain code 251A for an entity 133A and code a chain code 251B for an entity 133B. The chain code 251 and the entity 133 correspond one-to-one to each other.

Each chain code 251 includes an individual processing description 201 representing processing for the entity 133 corresponding to the chain code 251, the processing depending on the entity 133, and an entity definition description 203 representing a definition of the entity 133. The developer inputs a value registered in the entity 133 to the chain code 251 as an argument when the chain code 251 is instantiated. As a result, the entity 133 processed by the chain code 251 is implemented.

FIG. 3 illustrates the peer 110 according to the present embodiment.

The general-purpose chain code 121 is prepared for the peer 110. The general-purpose chain code 121 includes a general-purpose processing description 301 representing general-purpose processing that does not depend on the entity 133. The general-purpose chain code 121 performs processing for each of the one or more entities 133.

The schema definition information 131 exists outside the general-purpose chain code 121. The schema definition information 131 includes an entity definition description 303 for each of the one or more entities 133 associated with the general-purpose chain code 121. For example, the schema definition information 131 includes an entity definition description 303A representing an entity definition of the entity 133A and an entity definition description 303B representing an entity definition of the entity 133B.

For simple description of the present embodiment, the peer-to-peer network 100 is assumed to include one channel as its overlay, and thus one general-purpose chain code 121 exists in each peer 110. In each peer 110, the general-purpose chain code 121 may be prepared for each channel.

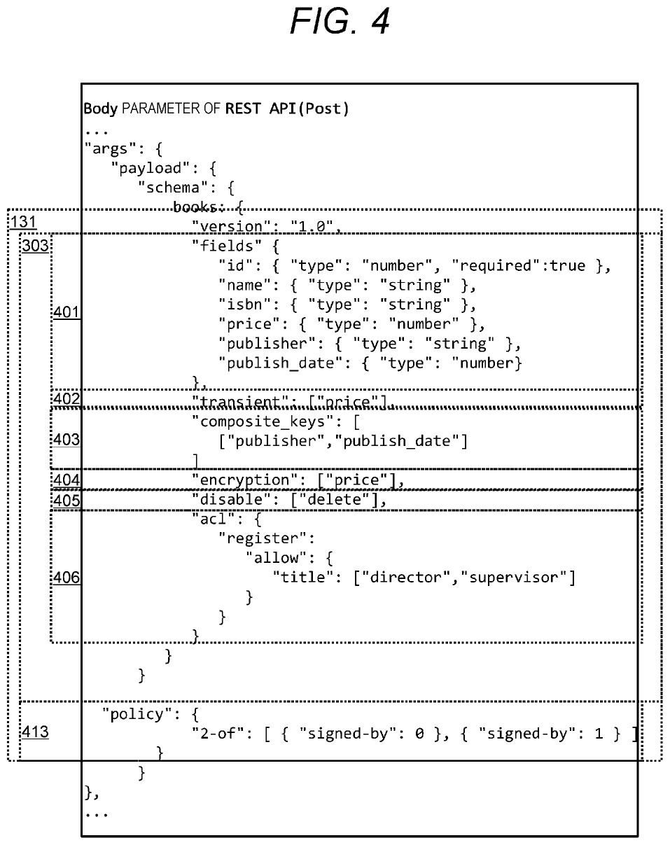

FIG. 4 illustrates an example of the schema definition information 131.

The schema definition information 131 is information in a JSON format, for example. The schema definition information 131 includes information that is hierarchically registered in a key value format. The schema definition information 131 also includes the entity definition description 303 for each entity 133 and an endorsement policy description 413 representing an endorsement policy.

The entity definition description 303 includes an entity field definition description 401, a private field definition description 402, a composite key definition description 403, an encryption field definition description 404, a method control description 405, and an access control list (ACL) description 406. The descriptions 401 to 406 includes the descriptions 402 to 405 that may be optional.

The entity field definition description 401 represents a definition of a field (e.g., a type, a field name) in the entity 133.

The private field definition description 402 indicates a definition of a field (e.g., a field name) stored in the private data collection 123.

The composite key definition description 403 represents a definition of a key (e.g., a field name) for search.

The encryption field definition description 404 represents a definition of a field (e.g., a field name) in which a value is encrypted.

The method control description 405 represents an unavailable method for the entity 133. The “method” referred to herein may be a type of processing, and specifically, may be an access method such as registration, reference, or deletion.

The ACL description 406 indicates at least one of an attribute value for which execution of processing is permitted and an attribute value for which execution of processing is prohibited. The “attribute value” may represent an attribute of an access source (e.g., a job title of an access source user) or represent an attribute of data to be accessed.

Although the schema definition information 131 may be input via a command line interface (CLI), it is created according to information input via a schema definition user interface (UI) in the present embodiment.

The schema definition information 131 illustrated in FIG. 4 allows interpretations below.
An entity with an entity name “books” is newly defined, and fields (components) include an id, a name, an isbn, a price, and a publish_date, in each of which a type is designated. Among them, a field name “id” is a required item (“required”).
The private data collection stores a field with a field name “price”. The field with the field name “price” is not stored in the state DB.
As a combination key of the composite key for search, a “publisher” and the “publish_date” are registered.
A value registered in a field with a field name “price” is encrypted using a common key.
A method “delete” is not executable.
A method “register” can be executed only by a user whose attribute value of “title” included in user information (e.g., X. 509 certificate) is a “director” or a “supervisor”.

All the fields can be designated to be stored in the private data collection. Specifically, when the field names of all the fields are designated as values of a key “transient”, all the fields are stored in the private data collection.

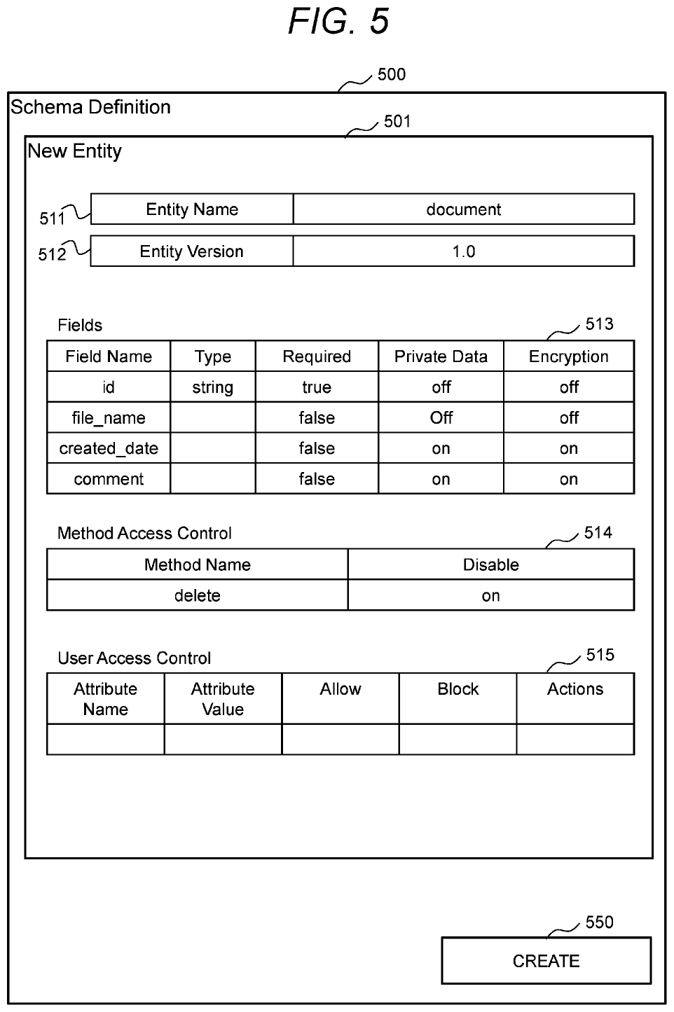

FIG. 5 illustrates an example of a schema definition UI.

A schema definition UI500 receives an input of an element of the schema definition information 131. The schema definition UI500 has an entity definition UI501 and a CREATE button 550. The entity definition UI501 receives information on the entity definition for each entity 133 associated with the general-purpose chain code 121.

The entity definition UI501 includes UI511 to UI515. The UI511 receives an input of an entity name. The UI512 receives an input of an entity version.

The UI513 receives an input of a definition (e.g., a field name, a type, whether it is essential, whether it is a storage target in the private data collection, and whether it is an encryption target) of each field in the entity 133.

The UI514 receives an input of a method unavailable to the entity 133. The UI515 receives an input of information (e.g., an attribute name, an attribute value, whether to permit, and a target operation) included in the ACL.

When the CREATE button 550 is pressed, the schema definition information 131 (e.g., see FIG. 4) as an argument is generated based on the information received via the schema definition UI500.

When using the schema definition UI500, the developer only needs to designate an element of the schema definition information 131 to create the schema definition information 131, and does not need to describe the schema definition information 131 itself in the JSON format. Although FIG. 5 illustrates that the schema definition UI500 includes one entity definition UI501, an entity definition can be input for each entity via the schema definition UI500 by a method for increasing the entity definition UI501 in a tab format in number as the number of entities increases, for example.

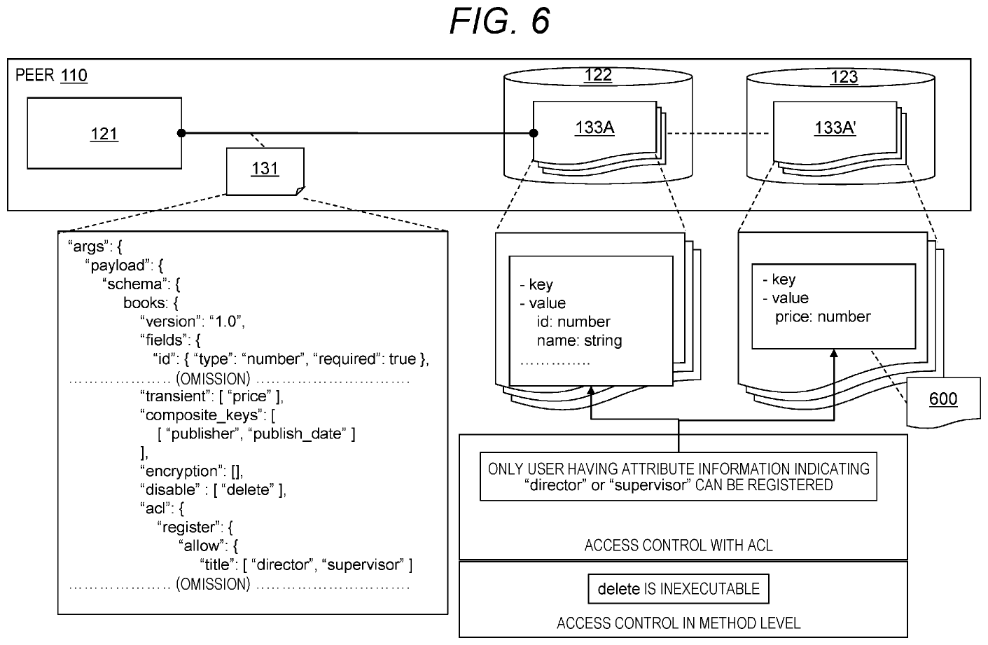

FIG. 6 illustrates an example of schema definition information 131 input to a general-purpose chain code 121, and storage and control according to the schema definition information 131.

The schema definition information 131 as information outside the general-purpose chain code 121 includes an entity definition including “books” as a value of the key “entity name”, for example. As a result, the entity 133A having the entity name “books” is stored in the state DB 122 by the general-purpose chain code 121.

The entity definition includes the “price” as a value of the key “transient”. As a result, a value of the field name “price” is stored for the entity 133A having the entity name “books” in the private data collection 123 instead of the state DB 122 by the general-purpose chain code 121 (see reference numeral 133 A′).

The entity definition includes the “delete” as a value of a key “disable”. As a result, when the general-purpose chain code 121 receives a deletion operation (transaction) for the entity 133A having the entity name “books”, the general-purpose chain code 121 does not execute deletion and returns an error.

The entity definition also includes ACL control information as a value of a key “acl”. The ACL control information includes a “register” as a value of a key “method name”, and a “title”, such as a “director”, or a “supervisor”, as a value of a key “allow”. As a result, when the general-purpose chain code 121 receives a registration operation for the entity 133A having the entity name “books”, the general-purpose chain code 121 determines whether an operation source (access source) has an attribute of the “director” or the “supervisor”, and executes registration when a result of the determination is true, and does not execute registration when a result of the determination is false.

To form the private data collection 123, a collection definition 600 and a transient map (not illustrated) are necessary.

The collection definition 600 is information in the JSON format, for example, and is stored in a local region (location other than the state DB 122 and the private data collection 123) of the peer 110. The collection definition 600 is designated as one of parameters when the general-purpose chain code 121 is instantiated. The collection definition 600 includes a key “name”. The general-purpose chain code 121 sets an entity name as a value of the key “name” to enable specifying an entity to which a field across the state DB 122 and the private data collection 123 belongs.

The transient map is treated separately from data registered in the state DB 122. The data set in the transient map has a characteristic of not being registered in the state DB 122 (and a ledger), and is used to transfer data stored in the private data collection 123, key information (common key) for encryption, and the like to the general-purpose chain code 121.

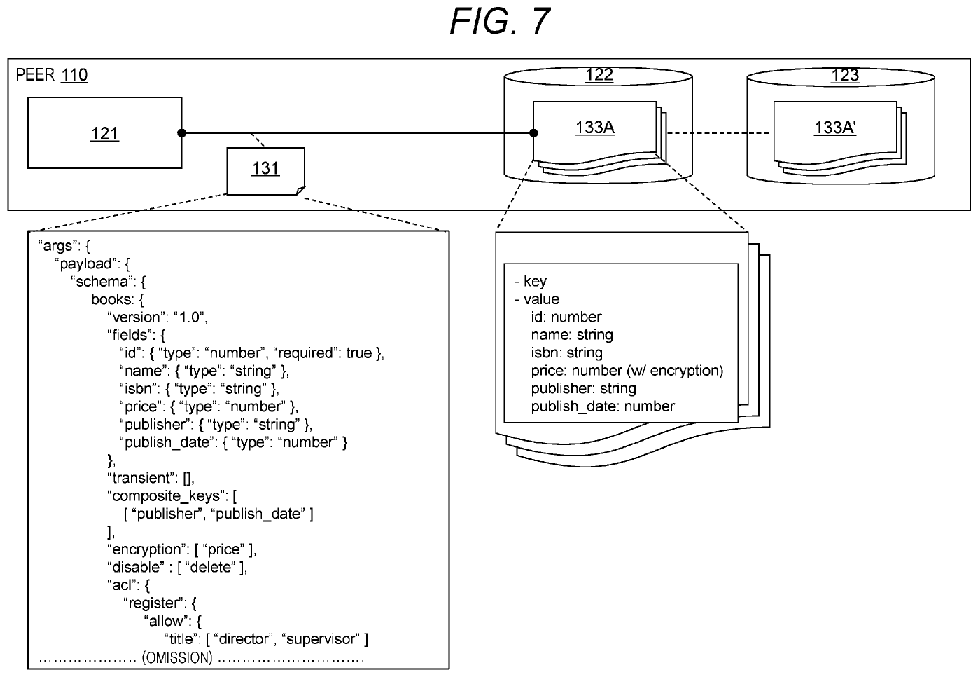

FIG. 7 illustrates another example of the schema definition information 131 input to the general-purpose chain code 121 and storage according to the schema definition information 131.

The entity name “books” has an entity definition including the “price” as a value of a key “encryption”. As a result, a value of the field name “price” is encrypted and registered in the state DB 122 for the entity 133A having the entity name “books” by the general-purpose chain code 121.

According to the present embodiment, each peer 110 includes the general-purpose chain code 121, and the general-purpose chain code 121 is associated with the schema definition information 131 including the entity definition description for each of one or more entities. Thus, the developer does not need to implement the chain code itself, and may define an entity definition (e.g., layout and accompanying data management requirements) in the schema definition information 131 as metadata. In other words, data registration and reference to the entity can be achieved without coding. As a result, even a developer who does not have deep knowledge about the Hyperledger Fabric can develop a blockchain application. That is, development productivity is improved.

According to the present embodiment, the general-purpose chain code 121 and the entity 133 are in a 1-to-n (n is a natural number) correspondence. Thus, even multiple entities 133 do not require each of multiple chain codes to be individually maintained, and thus only one general-purpose chain code 121 needs to be maintained. That is, a maintenance burden is reduced.

The peer 110 includes the general-purpose chain code 121 and the entity 133 that are in a 1-to-n correspondence, the entity 133 having the configuration and storage whose outline is as illustrated in FIG. 12. Each entity 133 has an entity name, and each entity 133 holds data in a key value format. A key may be defined by a set of an entity name and a unique key (an example of an ID of an entity). The unique key may be a serial number or an arbitrary character string. A value may be data in the JSON format, such as data designated as a storage target from a business application (not illustrated) executed by the user system 150. As described later, the schema definition information 131 is designated when the general-purpose chain code 121 is instantiated, and data registered as a value in the entity is consistent with the entity definition represented by the schema definition information 131.

Hereinafter, an example of processing performed in the present embodiment will be described.

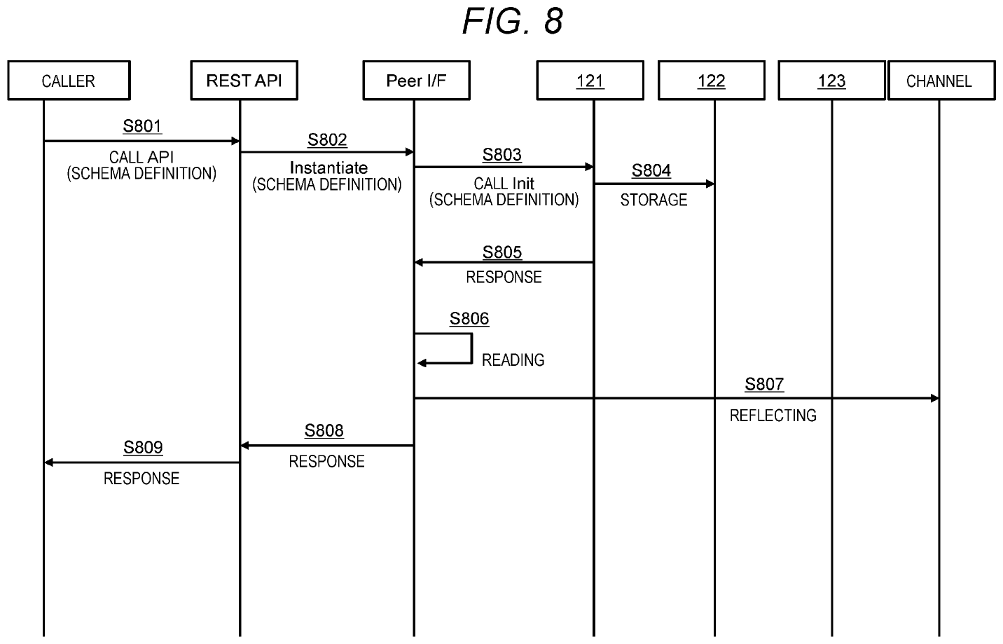

FIG. 8 illustrates an example of a flow of instantiation processing.

According to the Fabric Node SDK (an example of a smart contract development environment involved in a permissioned blockchain), the chain code is configured to receive information designated as an argument in instantiation of the chain code. The general-purpose chain code 121 is associated with an init function (an example of a function for instantiation).

A caller (e.g., a user system 150 used by a developer) calls an API of REST API (Fabric Node SDK) (S801). In the call, a schema definition is input. For example, the schema definition UI500 illustrated in FIG. 5 is provided to the caller to input the schema definition through the schema definition UI500.

The peer 110 includes a peer I/F (program as an interface to the REST API) that receives an instantiate request from the REST API (S802). The instantiate request is associated with the schema definition information 131. The schema definition information 131 complies with the schema definition input in S801.

In response to the instantiate request, the init function of the general-purpose chain code 121 is called from the peer I/F (S803). In the call, the schema definition information 131 serves as an argument. The general-purpose chain code 121 in which the init function has been called receives the schema definition information 131 as an argument, and stores the received schema definition information 131 in the state DB 122 (S804). When the general-purpose chain code 121 stores the schema definition information 131 in the state DB 122, completion is responded to the peer I/F (S805).

After receiving the response in S805, the peer I/F reads a collection definition from a local region (S806), and reflects a policy of a private data collection (a policy specified from the read collection definition) on a channel (S807). As a result, access control of the private data collection is achieved. The peer I/F then sends a response of completion to the REST API (S808). The REST API sends the response of completion to the caller (S809).

As described above, the instantiation processing according to the present embodiment allows the schema definition information 131 to be input instead of the value registered in the entity as the argument in the call of the init function, and to be stored in the state DB 122. As a result, the general-purpose chain code 121 can be instantiated.

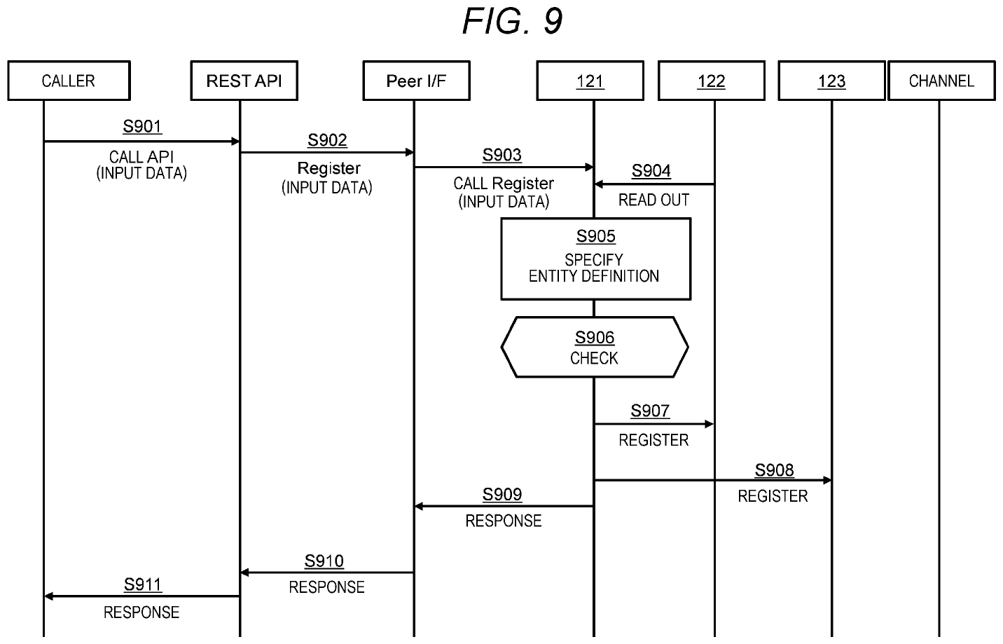

FIG. 9 illustrates an example of a flow of registration processing.

The caller (e.g., the user system 150 used by an operation manager) calls the REST API (S901). In the call, input data is input.

The peer I/F in the peer 110 receives a register request from the REST API (S902). The register request is associated with the input data input in S901.

In response to the register request, a register function (an example of a function for registration) of the general-purpose chain code 121 is called from the peer I/F (S903).

The general-purpose chain code 121 in which the register function has been called receives the input data and reads out the schema definition information 131 from the schema DB 122 (S904). The input data includes a data set including a value of a field name, and an entity name, for at least one entity. The data set associated with the entity name includes the following, for example.
A unique key for the entity.
A field name for each field and a value registered in the field for the state DB 122.
A transient map including a field name for each field and a value registered in the field (a common key for encryption may be further included) for the private data collection 123.

The general-purpose chain code 121 specifies an entity definition including an entity name matching the entity name designated in the received input data from the schema definition information 131 read out (S905). The general-purpose chain code 121 determines whether a data set corresponding to the entity name designated in the input data conforms to the entity definition specified in S905 (S906). The determination in S906 includes at least one of the following, for example.
Whether all the field names included in the data set in the input data are described in the entity field definition description 401 of the entity definition specified in S905.
Whether a type of a value registered in a field of a field name conforms to the type described in the entity field definition description 401 for each of all field names included in the data set in the input data.
Whether a field name corresponding to a value registered in the private data collection 123 is described in the private field definition description 402.

When the result of the determination in S906 is true, the general-purpose chain code 121 registers a value in a field according to the entity definition specified in S905, the value being designated in the input data and corresponding to the field (S907 and/or S908). As described above, the value is registered in the field when the result of the determination in S906 is true, so that an inappropriate value can be prevented from being registered in the field.

The general-purpose chain code 121 then returns a response to the peer I/F (S909). The peer I/F returns a response to the REST API in response to the response in S909 (S910). The REST API returns a response to the caller (S911).

As described above, the registration processing after the instantiation processing enables values to be registered in the respective multiple entities 133 represented by the schema definition information 131 for the general-purpose chain code 121. After that, when a value is added to an arbitrary entity 133 or a value in an arbitrary entity 133 is updated, registration processing as with the registration processing illustrated in FIG. 9 is performed. That is, the register function of the general-purpose chain code 121 is called, and input data including an entity name of the arbitrary entity 133 is input to the general-purpose chain code 121. The general-purpose chain code 121 reads out the schema definition information 131, determines whether a value after addition or update in the input data satisfies an entity definition corresponding to the entity name, and registers the value in the entity 133 when a result of the determination is true. The general-purpose chain code 121 also includes the general-purpose processing description 301 (see FIG. 3) that includes a registration processing description excluding the entity name. The general-purpose chain code 121 performs registration according to registration processing indicated by the registration processing description.

When the entity definition specified in S905 includes the private field definition description 402 (a field name designated as a field stored in the private data collection 123) and the input data includes a value registered in the field, the general-purpose chain code 121 stores the field of the field name designated in the description 402 in the private data collection 123, and registers a value corresponding to the field name in the field (S908). As described above, the value is registered in the private data collection 123. Although the present registration processing may cause two types of registration performed in S907 (registration of a value in the state DB 122) and registration subsequently performed in S908 (registration of a value in the private data collection 123), these types of registration may be treated as one transaction. Thus, when any one of the types of registration fails due to an error, the registration processing itself is considered to fail, and the error is returned to the caller. In other words, a response of completion may be notified to the caller when both S907 and S908 are normally completed.

When a field designated to be encrypted exists in at least one of S907 and S908, the general-purpose chain code 121 encrypts a value of a field name of the field using a common key (an example of an encryption key) in the input data and registers the encrypted value in the field of the field name. As a result, concealment of the value registered in an entity is achieved.

The input data may be for each entity or for multiple entities. Each time registration of a value to an entity is completed, the general-purpose chain code 121 in S909 may return a response including a unique key (an example of an ID) of the entity, and the unique key may be returned to the caller. As a result, the caller can grasp that registration of which of entities is completed.

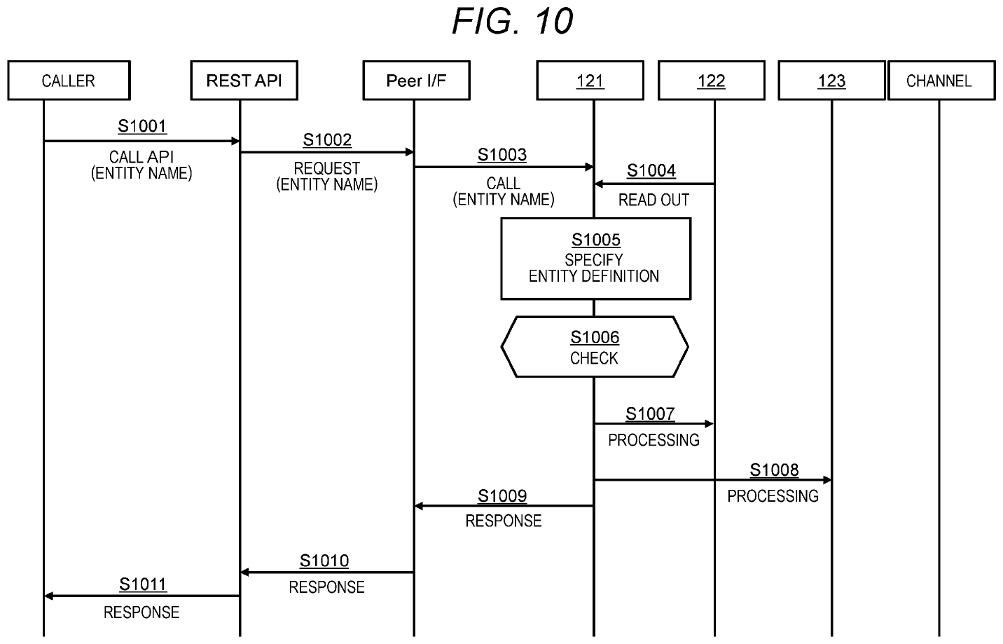

FIG. 10 illustrates an example of a flow of transaction processing other than registration processing.

Examples of the transaction processing other than the registration processing include reference processing (search processing) and deletion processing. The general-purpose processing description 301 (see FIG. 3) of the general-purpose chain code 121 includes a processing description excluding an entity name also for transaction processing other than registration processing, and the general-purpose chain code 121 performs processing according to processing indicated by the processing description. The transaction processing other than the registration processing is similar in outline of a processing flow to the registration processing.

That is, the caller calls the REST API (S1001). In the call, at least an entity name to be processed is input.

The peer I/F receives a request from the REST API (S1002). The request is associated with the input data input in S1001.

In response to the register request, a function of the general-purpose chain code 121 is called from the peer I/F (S1003). For example, in the case of reference (search), a function related to a query, such as a query function, a query public data function, a query private data function, a rich query public data function, or the rich query private data function, is called. In the case of deletion, a delete function is called.

The general-purpose chain code 121 in which the function is called reads out the schema definition information 131 from the schema DB 122 (S1004), and specifies an entity definition, including an entity name matching the input entity name, from the schema definition information 131 read out (S1005). The general-purpose chain code 121 determines whether the specified entity definition is satisfied (S1006).

When a result of the determination in S1006 is true, the general-purpose chain code 121 performs processing on an entity according to the entity definition specified in S1005 (S1007 and/or S1008). The general-purpose chain code 121 then returns a response to the peer I/F (S1009). The peer I/F returns a response to the REST API in response to the response in S1009 (S1010). The REST API returns a response to the caller (S1011).

When the called function is a function related to a query (an example of a reference function), the general-purpose chain code 121 receives a search condition in addition to the entity name. The search condition may be a search key or a search range. The general-purpose chain code 121 searches for a value conforming to the search condition key from an entity having the entity name, and returns a result of the search to the caller. As described above, the general-purpose chain code 121 executes the search in response to designation of an entity name. The search range may be determined by a type of function to be called instead of or in addition to designation under the search condition. For example, the search range may be the state DB 122 when the query public data function or the rich query public data function is called, and the search range may be the private data collection 123 when the query private data function or the rich query private data function is called.

When the description of the entity definition specified in S1005 includes the method control description 405 (see FIG. 4), the determination in S1006 includes a determination as to whether the method (type of processing) according to the called function cannot be executed in the method control description 405. The general-purpose chain code 121 executes processing when a result of this determination is true, but does not execute the processing (typically, returns an error) when a result of this determination is false. As described above, an inexecutable method can be defined in the entity definition, and such a method can be prevented from being executed.

When the description of the entity definition specified in S1005 includes the ACL description 406, the determination in S1006 includes a determination as to whether processing according to a method (type of processing) according to the called function is for an attribute value for which execution is permitted in the ACL description 406, and a determination as to whether the processing is for an attribute value for which execution is prohibited in the ACL description 406. That is, when the ACL description 406 designates an attribute value for which execution of processing is permitted and the attribute value corresponds to an attribute value related to processing to be executed, the general-purpose chain code 121 executes the processing to be executed. In contrast, when the ACL description 406 designates an attribute value for which execution of processing is prohibited and the attribute value corresponds to an attribute value related to processing to be executed, the general-purpose chain code 121 does not execute the processing to be executed (typically returns an error). As described above, at least one of the attribute value for which execution of processing is permitted and the attribute value for which execution of the processing is prohibited can be defined in the entity definition, and thus execution and non-execution of the processing can be controlled based on the attribute value.

The general-purpose chain code 121 may be required to be upgraded. Although the term, “upgrade” mentioned here, may be update of the description of the general-purpose chain code 121 itself, the “upgrade” in the present embodiment means that the init function is called and the schema definition information 131 in the state DB 122 is replaced with updated schema definition information designated as an argument.

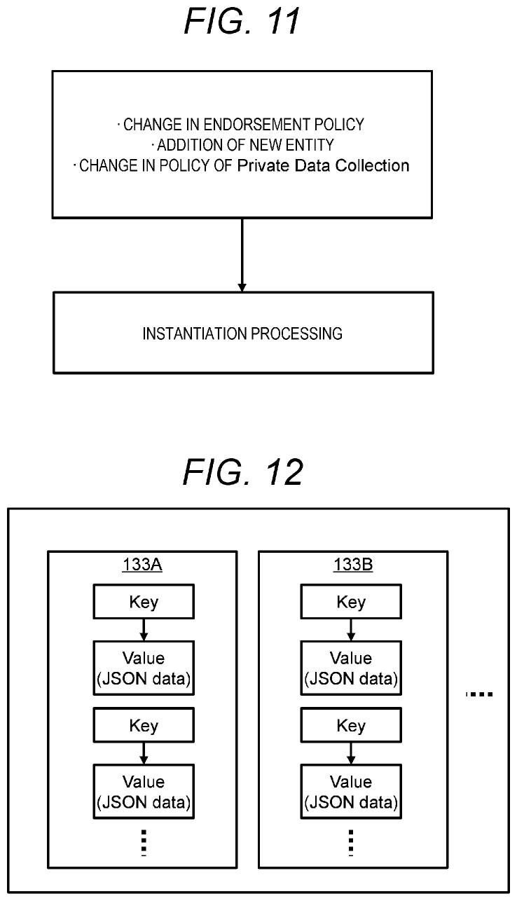

Examples of a case where at least part of predetermined information in the schema definition information 131 needs to be updated include at least one of the following as illustrated in FIG. 11.
Change in endorsement policy. Due to new peer participation or other reasons, the endorsement policy description 413 in the schema definition information 131 needs to be updated.
Addition of entities associated with the general-purpose chain code 121. For example, the general-purpose processing description 301 of the general-purpose chain code 121 includes a description on processing of prohibiting addition of a new entity. The general-purpose chain code 121 returns an error when detecting a request of adding a new entity.
Change in policy of the private data collection. To use the private data collection, collections definition needs to be designated as an option separately from providing the schema definition information 131 as an argument when the general-purpose chain code 121 is instantiated. Thus, when the policy (collections definition) is changed, the chain code needs to be upgraded. The collection definition is set for a channel on a blockchain network when the general-purpose chain code 121 is instantiated or upgraded. According to the protocol of the Hyperledger Fabric, the private data collection is a data format defined by the Hyperledger Fabric. When the private data collection is used to update the chain code itself (when it is instantiated or upgraded), the collection definition needs to be designated. Thus, when the private data collection is used to update the schema definition information 131 for the general-purpose chain code (to instantiate or upgrade the general-purpose chain code) in the present embodiment, the collection definition is designated.

Although an embodiment of the present invention has been described above, this is an example for describing the present invention, and is not intended to limit the scope of the present invention only to this embodiment. The present invention can be also implemented in various other forms. For example, the present invention may be applied to a blockchain other than the Hyperledger Fabric, or may be applied to any one of a permissioned blockchain (typically, a private or consortium-type blockchain) and a permissionless blockchain (typically, a public type blockchain).

### REFERENCE SIGNS LIST

121 general-purpose chain code

1. A system involved in a permissioned blockchain, the system comprising:
a peer-to-peer network composed of multiple authorized peers,
each of the multiple authorized peers having configurations of:
including a general-purpose smart contract that performs processing on an entity by being executed on the corresponding one of the multiple authorized peers and in which general-purpose processing independent of the entity is defined;
storing schema definition information including an entity definition of each of one or more entities associated with the general-purpose smart contract; and
allowing the general-purpose smart contract to receive designation of an entity name, specify an entity having the designated entity name from the schema definition information, and perform processing on the specified entity.

2. The system according to claim 1, wherein smart contract development environment involved in the permissioned blockchain causes a smart contract to receive information designated as an argument in instantiation of the smart contract,
the general-purpose smart contract is associated with a function for instantiation, and
the general-purpose smart contract in which the function for instantiation is called includes capabilities of:
receiving the schema definition information as the argument; and
storing the received schema definition information in a peer having the general-purpose smart contract.

3. The system according to claim 2, wherein the entity definition includes an entity name of an entity and a field name of each of one or more fields included in the entity,
the general-purpose smart contract is associated with a function for registration, and
the general-purpose smart contract in which a function for registration is called includes capabilities of:
receiving input data including a data set including a value of a field name and an entity name for at least one entity;
specifying an entity definition including an entity name matching the entity name designated in the input data from schema definition information stored in the peer; and
registering a value in a field of an entity conforming to the specified entity definition, the value being designated in the input data and corresponding to the field.

4. The system according to claim 3, wherein the general-purpose smart contract in which the function for registration is called includes capabilities of;
determining whether a data set corresponding to an entity name designated in the input data conforms to an entity definition specified using the entity name; and
registering a value in a field of the entity conforming to the specified entity definition, the value corresponding to the field, when a result of the determination is true.

5. The system according to claim 3, wherein the entity definition is allowed to include a field name designated as a field for partial disclosure, and
when the specified entity definition includes a field name designated as the field for partial disclosure and the input data includes a value registered in the field for partial disclosure, the general-purpose smart contract stores a field of the field name designated as the field for partial disclosure in a data store for partial disclosure in the peer, and registers a value corresponding to the field name in the field.

6. The system according to claim 3, wherein the entity definition is allowed to include a field name designated as a field for encryption,
when the specified entity definition includes a field name designated as the field for encryption,
the data set includes an encryption key for the field name, and
the general-purpose smart contract encrypts a value of the field name using the encryption key and registers the encrypted value in a field of the field name.

7. The system according to claim 3, wherein the input data includes an ID associated with an entity name, and
when the general-purpose smart contract is committed for a transaction that is performed in response to calling of the function for registration to register a value in a field of an entity corresponding to the entity name, the general-purpose smart contract returns a response to a caller, the response including an ID corresponding to the entity name.

8. The system according to claim 2, wherein the entity definition is allowed to include designation of a type of inexecutable processing for an entity corresponding to the entity definition, and
when a type of processing that is not executable is designated in an entity definition corresponding to a designated entity name in the schema definition information, and a type of processing to be executed for an entity having the designated entity name corresponds to the processing designated to be inexecutable, the general-purpose smart contract executes the processing to be executed.

9. The system according to claim 2, wherein the entity definition includes at least one of an attribute value for which execution of processing is permitted and an attribute value for which execution of processing is prohibited,
when the attribute value for which execution of processing is permitted is designated in an entity definition corresponding to a designated entity name in the schema definition information, and corresponds to an attribute value related to processing to be executed on an entity having the designated entity name, the general-purpose smart contract executes the processing to be executed, and
when the attribute value for which execution of processing is prohibited is designated in an entity definition corresponding to a designated entity name in the schema definition information, and corresponds to an attribute value related to processing to be executed on an entity having the designated entity name, the general-purpose smart contract does not execute the processing to be executed.

10. The system according to claim 2, wherein when at least some predetermined information in the schema definition information needs to be updated, the function for instantiation is called, and the general-purpose smart contract receives updated schema definition information designated as an argument.

11. The system according to claim 10, wherein the at least some predetermined information in the schema definition information needs to be updated in at least one of cases where:
an endorsement policy indicated by information described in the schema definition information is changed;
a new entity is added; and
a policy regarding a field for partial disclosure included in at least one entity definition is changed.

12. The system according to claim 1, wherein the general-purpose smart contract is associated with a function for reference, and
the general-purpose smart contract in which the function for reference is called includes capabilities of:
receiving designation of an entity name and a search condition from a caller;
searching for a value conforming to the search condition from the entity having the designated entity name; and
returning a result of the search to the caller.

13. A method for assisting in building a peer-to-peer network involved in a permissioned blockchain and including multiple authorized peers, the method comprising:
allowing a general-purpose smart contract to receive schema definition information designated as an argument when a function for instantiating the general-purpose smart contract to be executed on corresponding one of the multiple authorized peers is called,
the general-purpose smart contract being configured to perform processing on an entity by being executed on the corresponding one of the multiple authorized peers, and having definition of general-purpose processing independent of the entity,
the schema definition information including a description of an entity definition for each of one or more entities associated with the general-purpose smart contract; and
allowing the general-purpose smart contract to store the received schema definition information in the corresponding one of the multiple authorized peers.

14. A smart contract that is involved in a permissioned blockchain and performs processing on an entity by being executed on a peer in a peer-to-peer network, the smart contract causing the peer to execute capabilities of:
receiving schema definition information designated as an argument when a function for instantiation is called,
the schema definition information including a description of an entity definition for each of one or more entities associated with the smart contract;
receiving information designated as an argument in instantiation of the smart contract according to the smart contract development environment related to the permissioned blockchain; and
storing the received schema definition information in the peer.

15. The smart contract according to claim 14, further causing the peer to execute capabilities when the function for registration is called,
the capabilities including:
receiving input data including a data set including a value of a field name and an entity name for at least one entity,
the entity definition including an entity name of an entity and a field name of each of one or more fields included in the entity;
specifying an entity definition including an entity name matching the entity name designated in the input data from schema definition information stored in the peer; and
registering a value in a field of an entity conforming to the specified entity definition, the value being designated in the input data and corresponding to the field.
